(19) United States
(12) Patent Application Publication
(10) Pub. No.: US 2024/0153100 A1
(43) Pub. Date: May 9, 2024

(54) IMAGE FOREGROUND-BACKGROUND SEGMENTATION METHOD AND SYSTEM BASED ON SPARSE DECOMPOSITION AND GRAPH LAPLACIAN REGULARIZATION

(71) Applicant: Yangtze Delta Region Institute of University of Electronic Science and Technology of China, Huzhou, Huzhou (CN)

(72) Inventors: Junzheng Jiang, Guilin (CN); Tingfang Tan, Nanning (CN); Jiang Qian, Chengdu (CN)

(21) Appl. No.: 18/086,582

(22) Filed: Dec. 21, 2022

(30) Foreign Application Priority Data
Oct. 26, 2022 (CN) 2022113176054

(51) Int. Cl. G06T 7/194; G06T 7/11

(52) U.S. Cl. CPC G06T 7/194; G06T 7/11

(57) ABSTRACT

An image foreground-background segmentation method and system based on sparse decomposition and graph Laplacian regularization are disclosed. Firstly, an image is divided into a plurality of non-overlapping image blocks; Then, a foreground-background segmentation model of the image is established according to the image blocks; An image segmentation problem is divided into several sub-problems, which are solved by iteration; Finally, after the iteration, solutions of the problem are obtained; The obtained solutions are respectively matrixed and patched to obtain a foreground image, which is a foreground image of the whole image. The image foreground-background segmentation method uses the linear combination of graph Fourier basis functions to better represent the smooth background region. In addition, the graph Laplacian regularization is used to characterize the connectivity of foreground text and graphics while keeping sharp foreground text and graphics contours. The experimental results show that this method has better foreground-background segmentation effect.

### TECHNICAL FIELD

The disclosure relates to the technical field of image processing, particularly to an image foreground-background segmentation method based on sparse decomposition and graph Laplacian regularization.

### BACKGROUND

The foreground-background segmentation of images, that is, trying to decompose an image into foreground and background components, plays a fundamental role in image processing and computer vision applications, such as image compression, medical image segmentation and text extraction. As an important preprocessing step in some image applications, the foreground-background segmentation plays an important role in the subsequent processing.

At present, many foreground-background segmentation algorithms for still images have been proposed. Among them, Tony Lin proposed compound image compression for real-time computer screen image transmission, Shervin Minaee proposed screen content image segmentation using least absolute deviation fitting (abbreviated as LAD method), Shervin Minaee proposed screen content image segmentation using sparse decomposition and total variation minimization (abbreviated as SDTV method), etc. The LAD method fitted a smooth model to an image and divided pixels into background or foreground, but there were isolated points in the segmented foreground. On the basis of sparse decomposition, the SDTV method used total variation minimization for a foreground component, which promoted the connectivity of foreground pixels and made the segmentation effect better than the LAD method. However, these methods still could not effectively characterize the high correlations between pixels.

Therefore, a method to improve the foreground-background segmentation effect of images needs to be further introduced.

### SUMMARY

In view of this, a purpose of the disclosure is to provide an image foreground-background segmentation method based on sparse decomposition and graph Laplacian regularization, which can improve the depiction effect of pixel correlation and promote the connectivity of foreground pixels, thus improving the foreground-background segmentation effect of images.

In order to achieve the above purpose, the disclosure provides a technical scheme as follows.

The disclosure provides an image foreground-background segmentation method based on sparse decomposition and graph Laplacian regularization, which includes the following steps:
step 1) dividing an image into a plurality of non-overlapping image blocks;
step 2) establishing a foreground-background segmentation model of the image block, where the foreground-background segmentation model is expressed as follows:

$${min}_{{s}_{r} , {α}_{r}} {‖ {α}_{r} ‖}_{0} + τ {‖ {s}_{r} ‖}_{0} + γ {s}_{r}^{T} {L}_{{𝒢}_{r}} {s}_{r} \qquad ( 3 )$$

$$s . t . {f}_{r} = {P}_{r} {α}_{r} + {s}_{r}$$

where r=1, . . . ,rₘₐₓ; τ and γ are regularization parameters; ∥αᵣ∥₀ represents minimizing the nonzeros entries of the parameter αᵣ by using 10-norm; ∥sᵣ∥₀ represents foreground pixels sᵣ where the number of non-zero components should be smaller; sᵣ^{T} [symbol] sᵣ represents a graph Laplacian regularization term, which is used to characterize the connectivity of foreground text and graphics; fᵣ=Pᵣαᵣ+sᵣ represents a constrain term; fᵣ corresponds to vectorization of Fᵣ(x,y) and sᵣ corresponds to vectorization of Sᵣ(x,y); Pᵣ is a matrix with a size l²×M, and αᵣ=[α_{r,1}, . . . , α_{r,M}]^{T};
step 3) using a 11-norm to deal with a convex problem according to the foreground-background segmentation model, and obtaining the following problem:

$${min}_{{s}_{r} , {α}_{r}} {‖ {α}_{r} ‖}_{1} + τ {‖ {s}_{r} ‖}_{1} + γ {s}_{r}^{T} {L}_{{𝒢}_{r}} {s}_{r} \qquad ( 4 )$$

$$s . t . {f}_{r} = {P}_{r} {α}_{r} + {s}_{r}$$

step 4) dividing the above problem into a plurality of sub-problems, and solving the plurality of sub-problems by iteration according to the foreground-background segmentation model of the image established by formula (3);
step 5) after the iteration of the above step 4), obtaining the solutions sᵣ (r=1, . . . ,rₘₐₓ) of above problem; matrixing sᵣ, and patching the sᵣ into S, which is the foreground image of the whole image.

In an embodiment, the plurality of non-overlapping image blocks in step 1) are obtained by the following manner:
dividing the image into rₘₐₓ numbers of non-overlapping image blocks; where in each of the non-overlapping image blocks has a size of l×l, and the r-th image block is expressed as formula (1):

Fᵣ(x,y)=Σₘ₌₁^{M}α_{r,m}P_{r,m}(x,y)+Sᵣ(x,y) (1)
where r=1, . . . ,rₘₐₓ; x represents a horizontal coordinate and y represents a vertical coordinate; Σₘ₌₁^{M}α_{r,m}P_{r,m}(x,y) corresponds to a smooth background region, P_{r,m}(x,y) represents a graph Fourier basis; α_{r,m}, represents a model parameter; Sᵣ(x,y) corresponds to the foreground pixels;
by vectorizing the matrices into the vectors, recasting the above formula (1) as follows:

fᵣ=Pᵣαᵣ+sᵣ (2)
where fᵣ corresponds to the vectorization of Fᵣ(x,y) and sᵣ corresponds to the vectorization of Sᵣ(x,y); Pᵣ is the matrix with the size l²×M, and αᵣ=[α_{r,1}, . . . ,α_{r,M}]^{T}.

In an embodiment, the plurality of sub-problems in step 4) are obtained by the following manner:
before using an alternating direction method of multipliers to solve the above problem, and rewriting the above problem equivalently as follows:

$${min}_{{α}_{r} , {x}_{r} , {y}_{r} , {s}_{r}} {‖ {x}_{r} ‖}_{1} + τ {‖ {y}_{r} ‖}_{1} + γ {s}_{r}^{T} {L}_{{𝒢}_{r}} {s}_{r} \qquad ( 5 )$$

$$s . t . {x}_{r} = {α}_{r} , {y}_{r} = {f}_{r} - {P}_{r} {α}_{r} , {y}_{r} = {s}_{r}$$

where xᵣ is an auxiliary variable, which is equivalent to αᵣ before equivalent rewriting; yᵣ is another auxiliary variable, which is equivalent to sᵣ before equivalent rewriting, so as to facilitate the subsequent use of the alternating direction method of multipliers.
using the alternating direction method of multipliers to express an augmented Lagrangian function of the above problem as follows:

$$ℓ ( {α}_{r} , {x}_{r} , {y}_{r} , {s}_{r} , {u}_{r} , {v}_{r} , {w}_{r} ) = {‖ {x}_{r} ‖}_{1} + τ {‖ {y}_{r} ‖}_{1} + γ {s}_{r}^{T} {L}_{{𝒢}_{r}} {s}_{r} + 〈 {u}_{r} , {x}_{r} - {α}_{r} 〉 + 〈 {v}_{r} , {y}_{r} + {P}_{r} {α}_{r} - {f}_{r} 〉 + 〈 {w}_{r} , {y}_{r} - {s}_{r} 〉 + \frac{ρ}{2} ( {‖ {x}_{r} - {α}_{r} ‖}_{2}^{2} + {‖ {y}_{r} + {P}_{r} {α}_{r} - {f}_{r} ‖}_{2}^{2} + {‖ {y}_{r} - {s}_{r} ‖}_{2}^{2} ) \qquad ( 6 )$$

where uᵣ, vᵣ, wᵣ represent Lagrange multipliers of a dual variable; [symbol] ⋅,⋅ [symbol] represents an inner product; ρ represents a penalty parameter; and [symbol] represents a graph Laplacian matrix;
dividing the above problem into the plurality of sub-problems and solving them one by one by the iteration:

$${α}_{r}^{( k + 1 )} = {argmin}_{{α}_{r}} ℓ ( {α}_{r} , {x}_{r}^{( k )} , {y}_{r}^{( k )} , {s}_{r}^{( k )} , {u}_{r}^{( k )} , {v}_{r}^{( k )} , {w}_{r}^{( k )} ) \qquad ( 7 )$$

$${x}_{r}^{( k + 1 )} = {argmin}_{{x}_{r}} ℓ ( {α}_{r}^{( k + 1 )} , {x}_{r} , {y}_{r}^{( k )} , {s}_{r}^{( k )} , {u}_{r}^{( k )} , {v}_{r}^{( k )} , {w}_{r}^{( k )} ) \qquad ( 8 )$$

$${y}_{r}^{( k + 1 )} = {argmin}_{{y}_{r}} ℓ ( {α}_{r}^{( k + 1 )} , {x}_{r}^{( k + 1 )} , {y}_{r} , {s}_{r}^{( k )} , {u}_{r}^{( k )} , {v}_{r}^{( k )} , {w}_{r}^{( k )} ) \qquad ( 9 )$$

$${s}_{r}^{( k + 1 )} = {argmin}_{{s}_{r}} ℓ ( {α}_{r}^{( k + 1 )} , {x}_{r}^{( k + 1 )} , {y}_{r}^{( k + 1 )} , {s}_{r} , {u}_{r}^{( k )} , {v}_{r}^{( k )} , {w}_{r}^{( k )} ) \qquad ( 10 )$$

$${u}_{r}^{( k + 1 )} = {u}_{r}^{( k )} + ρ ( {x}_{r}^{( k + 1 )} - {α}_{r}^{( k + 1 )} ) \qquad ( 11 )$$

$${v}_{r}^{( k + 1 )} = {v}_{r}^{( k )} + ρ ( {y}_{r}^{( k + 1 )} - {P}_{r} {α}_{r}^{( k + 1 )} - {f}_{r} ) \qquad ( 12 )$$

$${w}_{r}^{( k + 1 )} = {w}_{r}^{( k )} + ρ ( {y}_{r}^{( k + 1 )} - {s}_{r}^{( k + 1 )} ) \qquad ( 13 )$$

where [symbol] * represents a value of the symbol ⋅ when the formula * reaches the minimum value; k represents the k-th iteration; *^{(k+1)} represents a result of the formula * after the (k+1)-th iteration; and *^{(k)} represents a result of the formula * after the k-th iteration.

In an embodiment, solving the plurality of sub-problems by the iteration, includes:
extracting all terms containing αᵣ, xᵣ, yᵣ, sᵣ from formula (6) respectively;
determining termination conditions of the iteration, and stopping the iteration in response to the termination conditions being met; the termination conditions of the iteration are as follows:

∥xᵣ^{(k+1)}−αᵣ^{(k+1)}∥_{∞}≤ε₁, ∥yᵣ^{(k+1)}+Pᵣαᵣ^{(k+1)}−fᵣ∥_{∞}≤ε₂, and ∥yᵣ^{(k+1)}−sᵣ^{(k+1)}∥_{∞}≤ε₃;

where ∥⋅∥_{∞} is an infinite norm, which represents the maximum absolute value of all elements in a vector; ε₁, ε₂, and ε₃ are numbers as small as possible, and are constraint parameters respectively; αᵣ^{(k+1)} represents a result of αᵣ after the (k+1)-th iteration; sᵣ^{(k+1)} represents a result of sᵣ after the (k+1)-th iteration; xᵣ^{(k+1)} represents a result of xᵣ after the (k+1)-th iteration; xᵣ represents an auxiliary variable, which is equivalent to αᵣ; yᵣ^{(k+1)} represents a result of yᵣ after the (k+1)-th iteration; yᵣ represents an auxiliary variable, which is equivalent to sᵣ.

In an embodiment, in step 4), all terms containing αᵣ are extracted from formula (6) and the first sub-problem is solved by the following manner:

$${α}_{r}^{( k + 1 )} = {argmin}_{{α}_{r}} 〈 {u}_{r}^{( k )} , {x}_{r}^{( k )} - {α}_{r} 〉 + 〈 {v}_{r}^{( k )} , {y}_{r}^{( k )} + {P}_{r} {α}_{r} - {f}_{r} 〉 + \frac{ρ}{2} ( {‖ {x}_{r}^{( k )} - {α}_{r} ‖}_{2}^{2} + {‖ {y}_{r}^{( k )} + {P}_{r} {α}_{r} - {f}_{r} ‖}_{2}^{2} ) \qquad ( 14 )$$

a problem of formula (14) is a least squares problem, which has a closed-form solution as follows:

αᵣ^{(k+1)}=(ρI+ρPᵣ^{T}Pᵣ)⁻¹(uᵣ^{(k)}−Pᵣ^{T}vᵣ^{(k)}+ρxᵣ^{(k)}+ρPᵣ^{T}(fᵣ−yᵣ^{(k)})) (15)
where I represent a identity matrix.

In an embodiment, in step 4), all terms containing xᵣ are extracted from formula (6) and a soft thresholding shrinkage operator is used to solve the second sub-problem by the following manner:

$${x}_{r}^{( k + 1 )} = {argmin}_{{x}_{r}} {‖ {x}_{r} ‖}_{1} + 〈 {u}_{r}^{( k )} , {x}_{r} - {α}_{r}^{( k + 1 )} 〉 + \frac{ρ}{2} {‖ {x}_{r} - {α}_{r}^{( k + 1 )} ‖}_{2}^{2} = {argmin}_{{x}_{r}} {‖ {x}_{r} ‖}_{1} + \frac{ρ}{2} {‖ {x}_{r} - ( {α}_{r}^{( k + 1 )} - \frac{{u}_{r}^{( k )}}{ρ} ) ‖}_{2}^{2} \qquad ( 16 )$$

by referring to the following soft thresholding shrinkage operator:

$$soft ( ϕ , Δ ) = \{ \begin{matrix}ϕ - Δ , & ϕ > Δ \\ ϕ + Δ , & ϕ < - Δ \\ 0 , & otherwise\end{matrix} \qquad ( 17 )$$

where ϕ∈ [symbol] , Δ>0; and a solution of the second sub-problem of xᵣ is as follows:

$${x}_{r}^{( k + 1 )} = soft ( {α}_{r}^{( k + 1 )} - \frac{{u}_{r}^{( k )}}{ρ} , \frac{1}{ρ} ) \qquad ( 18 )$$

where ϕ represents a variable; [symbol] represents a set of real numbers; Δ represents a threshold value.

In an embodiment, in step 4), all terms containing yᵣ are extracted from formula (6), and the soft thresholding shrinkage operator is used to solve the third sub-problem by the following manner:

$${y}_{r}^{( k + 1 )} = {argmin}_{{y}_{r}} τ {‖ {y}_{r} ‖}_{1} + 〈 {v}_{r}^{( k )} , {y}_{r} - {P}_{r} {α}_{r}^{( k + 1 )} - {f}_{r} 〉 + 〈 {w}_{r}^{( k )} , {y}_{r} - {s}_{r}^{( k )} 〉 + \frac{ρ}{2} ( {‖ {y}_{r} - {P}_{r} {α}_{r}^{( k + 1 )} - {f}_{r} ‖}_{2}^{2} + {‖ {y}_{r} - {s}_{r}^{( k )} ‖}_{2}^{2} ) = {argmin}_{{y}_{r}} τ {‖ {y}_{r} ‖}_{1} + ρ {‖ {y}_{r} - \frac{1}{2} ( {f}_{r} + {s}_{r}^{( k )} - {P}_{r} {α}_{r}^{( k + 1 )} - \frac{1}{ρ} ( {v}_{r}^{( k )} + {w}_{r}^{( k )} ) ) ‖}_{2}^{2} = soft ( \frac{1}{2} ( {f}_{r} + {s}_{r}^{( k )} - {P}_{r} {α}_{r}^{( k + 1 )} - \frac{1}{ρ} ( {v}_{r}^{( k )} + {w}_{r}^{( k )} ) ) , \frac{τ}{2 ρ} ) \qquad ( 19 )$$

where τ represents the regularization parameter.

In an embodiment, in step 4), all terms containing sᵣ are extracted from formula (6), and a fourth sub-problem is solved by the following manner:

$${s}_{r}^{( k + 1 )} = {argmin}_{{s}_{r}} γ {s}_{r}^{T} {L}_{{𝒢}_{r}} {s}_{r} + 〈 {w}_{r}^{( k )} , {y}_{r}^{( k )} - {s}_{r} 〉 + \frac{ρ}{2} {‖ {y}_{r}^{( k + 1 )} - {s}_{r} ‖}_{2}^{2} ) = {( 2 γ {L}_{{𝒢}_{r}} + ρI )}^{- 1} ( {w}_{r}^{( k )} + ρ {y}_{r}^{( k + 1 )} ) \qquad ( 20 )$$

where uᵣ is obtained after the iteration:

uᵣ^{(k+1)}=uᵣ^{(k)}+ρ(xᵣ^{(k+1)}−αᵣ^{(k+1)}) (21)
where vᵣ is obtained after the iteration:

vᵣ^{(k+1)}=vᵣ^{(k)}+ρ(yᵣ^{(k+1)}+Pᵣαᵣ^{(k+1)}−fᵣ) (22)
where wᵣ is obtained after the iteration:

wᵣ^{(k+1)}=wᵣ^{(k)}+ρ(yᵣ^{(k+1)}−sᵣ^{(k+1)}) (23)
where [symbol] represents the graph Laplacian matrix.

In addition, the disclosure provides an image foreground-background segmentation system based on sparse decomposition and graph Laplacian regularization, including a memory, a processor and a computer program stored in the memory and executable on the processor, and the processor is configured, when executes the computer program, to implements the above method.

The disclosure has the advantages that:
compared with the existing image foreground-background segmentation methods, the image foreground-background segmentation method based on sparse decomposition and graph Laplacian regularization provided by the disclosure uses the linear combination of graph Fourier basis functions to better represent the smooth background region. In addition, the graph Laplacian regularization is used to characterize the connectivity of foreground text and graphics while keeping sharp foreground text and graphics contours. The experimental results show that the method provided by the disclosure has better foreground-background segmentation effect.

Other advantages, purposes and features of the disclosure will be set forth in part in the following description, and in part will be obvious to those skilled in the art based on the following study, or may be taught by the practice of the disclosure. The purposes and other advantages of the disclosure can be realized and obtained by the following description.

### BRIEF DESCRIPTION OF DRAWINGS

In order to make purposes, technical schemes and beneficial effects of the disclosure clearer, the disclosure provides the following drawings for illustration:

FIG. 1 shows an original synthetic image in a simulation example 1.

FIG. 2 shows a ground truth foreground in the simulation example 1.

FIG. 3 shows a foreground map by the technical scheme of the disclosure in the simulation example 1.

FIG. 4 shows a foreground map by the LAD method in the simulation example 1.

FIG. 5 shows a foreground map by the SDTV method in the simulation example 1.

FIG. 6 shows an original image of screen content in a simulation example 2.

FIG. 7 shows a foreground map by the technical scheme of the disclosure in the simulation example 2.

FIG. 8 shows a foreground map by the LAD method in the simulation example 2.

FIG. 9 shows a foreground map by the SDTV method in the simulation example 2.

### DETAILED DESCRIPTION OF EMBODIMENTS

The disclosure will be further explained with reference to the following drawings and specific embodiments, so that those skilled in the art can better understand the disclosure and implement it. However, the embodiments cited are not to be taken as limitations of the disclosure.

### Embodiment 1

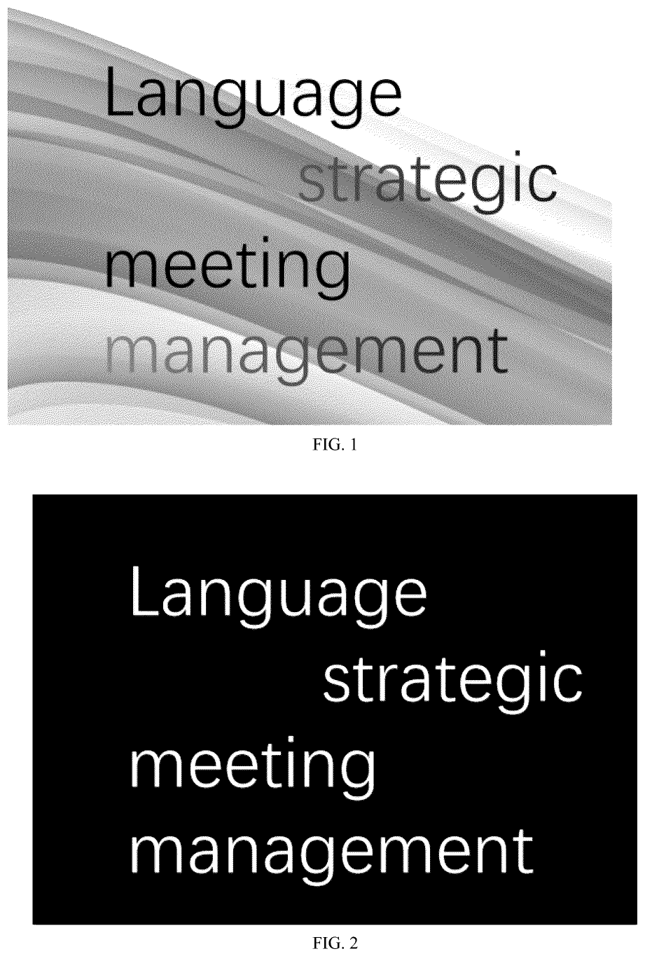

Please refer to FIG. 1 to FIG. 5, an embodiment of the disclosure provides an image foreground-background segmentation method based on sparse decomposition and graph Laplacian regularization, including steps as follows.

Step 1) an image is divided to rₘₐₓ numbers of non-overlapping image blocks with the size of l×l, and the r-th image block is expressed as:

Fᵣ(x,y)=Σₘ₌₁^{M}α_{r,m}P_{r,m}(x,y)+Sᵣ(x,y) (1)
where r=1, . . . , rₘₐₓ; x represents a horizontal coordinate and y represents a vertical coordinate; Σₘ₌₁^{M}α_{r,m}P_{r,m}(x,y) corresponds to a smooth background region, P_{r,m}(x,y) represents a graph Fourier basis; α_{r,m} represents a model parameter; Sᵣ(x,y) corresponds to foreground pixels. By vectorizing the matrix into the vector, the above formula (1) is re-described as follows:

fᵣ=Pᵣαᵣ+sᵣ (2)
where fᵣ corresponds to the vectorization of Fᵣ(x,y) and sᵣ corresponds to the vectorization of Sᵣ(x,y); Pᵣ is the matrix with the size l²×M, and αᵣ=[α_{r,1}, . . . ,α_{r,M}]^{T}.

Step 2) a foreground-background segmentation model of the image is established according to the image representation method in step 1), and the foreground-background segmentation model is expressed as follows:

$${min}_{{s}_{r} , {α}_{r}} {‖ {α}_{r} ‖}_{0} + τ {‖ {s}_{r} ‖}_{0} + γ {s}_{r}^{T} {L}_{{𝒢}_{r}} {s}_{r} \qquad ( 3 )$$

$$s . t . {f}_{r} = {P}_{r} {α}_{r} + {s}_{r}$$

where τ and γ are regularization parameters; ∥αᵣ∥₀ represents minimizing the nonzeros entries of the parameter αᵣ by using 10-norm, so as to avoid over-fitting of the smooth model on the foreground pixels; ∥sᵣ∥₀ represents foreground pixels sᵣ with smaller number of non-zero components; sᵣ^{T} [symbol] sᵣ represents a graph Laplacian regularization term, which is used to characterize the connectivity of foreground text and graphics; and fᵣ=Pᵣαᵣ+sᵣ represents a constrain term;

Step 3) according to the foreground-background segmentation model in step 2), for the first two terms, because the 10-norm is non-convex, its approximate 11-norm is used to deal with the convex problem. The above problem is equivalently rewritten as follows:

$${min}_{{s}_{r} , {α}_{r}} {‖ {α}_{r} ‖}_{1} + τ {‖ {s}_{r} ‖}_{1} + γ {s}_{r}^{T} {L}_{{q}_{r}} {s}_{r} \qquad ( 4 )$$

$$s . t . {f}_{r} = {P}_{r} {α}_{r} + {s}_{r}$$

Step 4) The model is solved according to the model established in step 3):

The alternating direction method of multipliers (ADMM) is used to solve the above problem. Firstly, the above problem is equivalently rewritten as follows:

$${min}_{{α}_{r} , {x}_{r} , {y}_{r} , {s}_{r}} {‖ {x}_{r} ‖}_{1} + τ {‖ {y}_{r} ‖}_{1} + γ {s}_{r}^{T} {L}_{{𝒢}_{r}} {s}_{r} \qquad ( 5 )$$

$$s . t . {x}_{r} = {α}_{r} , {y}_{r} = {f}_{r} - {P}_{r} {α}_{r} , {y}_{r} = {s}_{r}$$

where xᵣ is equivalent to αᵣ before equivalent rewriting, yᵣ is equivalent to sᵣ before equivalent rewriting, so as to facilitate the subsequent use of the ADMM.

The ADMM is used to express an augmented Lagrangian function of the above problem as follows:

$$ℓ ( {α}_{r} , {x}_{r} , {y}_{r} , {s}_{r} , {u}_{r} , {v}_{r} , {w}_{r} ) = {‖ {x}_{r} ‖}_{1} + τ {‖ {y}_{r} ‖}_{1} + γ {s}_{r}^{T} {L}_{{𝒢}_{r}} {s}_{r} + 〈 {u}_{r} , {x}_{r} - {α}_{r} 〉 + 〈 {v}_{r} , {y}_{r} + {P}_{r} {α}_{r} - {f}_{r} 〉 + 〈 {w}_{r} , {y}_{r} - {s}_{r} 〉 + \frac{ρ}{2} ( {‖ {x}_{r} - {α}_{r} ‖}_{2}^{2} + {‖ {y}_{r} + {P}_{r} {α}_{r} - {f}_{r} ‖}_{2}^{2} + {‖ {y}_{r} - {s}_{r} ‖}_{2}^{2} ) \qquad ( 6 )$$

where uᵣ, vᵣ, wᵣ represent Lagrange multipliers of a dual variable; [symbol] ⋅,⋅ [symbol] represents an inner product, ρ represents a penalty parameter, and [symbol] represents a graph Laplacian matrix.

The above problem is divided to a plurality of sub-problems, and the plurality of sub-problems are solved one by one by iteration:

$${α}_{r}^{( k + 1 )} = {argmin}_{{α}_{r}} ℓ ( {α}_{r} , {x}_{r}^{( k )} , {y}_{r}^{( k )} , {s}_{r}^{( k )} , {u}_{r}^{( k )} , {v}_{r}^{( k )} , {w}_{r}^{( k )} ) \qquad ( 7 )$$

$${x}_{r}^{( k + 1 )} = {argmin}_{{x}_{r}} ℓ ( {α}_{r}^{( k + 1 )} , {x}_{r} , {y}_{r}^{( k )} , {s}_{r}^{( k )} , {u}_{r}^{( k )} , {v}_{r}^{( k )} , {w}_{r}^{( k )} ) \qquad ( 8 )$$

$${y}_{r}^{( k + 1 )} = {argmin}_{{y}_{r}} ℓ ( {α}_{r}^{( k + 1 )} , {x}_{r}^{( k + 1 )} , {y}_{r} , {s}_{r}^{( k )} , {u}_{r}^{( k )} , {v}_{r}^{( k )} , {w}_{r}^{( k )} ) \qquad ( 9 )$$

$${s}_{r}^{( k + 1 )} = {argmin}_{{s}_{r}} ℓ ( {α}_{r}^{( k + 1 )} , {x}_{r}^{( k + 1 )} , {y}_{r}^{( k + 1 )} , {s}_{r} , {u}_{r}^{( k )} , {v}_{r}^{( k )} , {w}_{r}^{( k )} ) \qquad ( 10 )$$

$${u}_{r}^{( k + 1 )} = {u}_{r}^{( k )} + ρ ( {x}_{r}^{( k + 1 )} - {α}_{r}^{( k + 1 )} ) \qquad ( 11 )$$

$${v}_{r}^{( k + 1 )} = {v}_{r}^{( k )} + ρ ( {y}_{r}^{( k + 1 )} - {P}_{r} {α}_{r}^{( k + 1 )} - {f}_{r} ) \qquad ( 12 )$$

$${w}_{r}^{( k + 1 )} = {w}_{r}^{( k )} + ρ ( {y}_{r}^{( k + 1 )} - {s}_{r}^{( k + 1 )} ) \qquad ( 13 )$$

where [symbol] * represents a value of the symbol ⋅ when the formula * reaches a minimum value; k represents the k-th iteration; *^{(k+1)} represents a result of the formula * after the (k+1)-th iteration; and *^{(k)} represents a result of the formula * after the k-th iteration.

Therefore, the above problem is turned to solve four main sub-problems αᵣ, xᵣ, yᵣ, sᵣ.

All terms containing αᵣ are extracted from formula (6), and the first sub-problem is solved as follows.

$${α}_{r}^{( k + 1 )} = {argmin}_{{α}_{r}} 〈 {u}_{r}^{( k )} , {x}_{r}^{( k )} - {α}_{r} 〉 + 〈 {v}_{r}^{( k )} , {y}_{r}^{( k )} + {P}_{r} {α}_{r} - {f}_{r} 〉 + \frac{ρ}{2} ( {‖ {x}_{r}^{( k )} - {α}_{r} ‖}_{2}^{2} + {‖ {y}_{r}^{( k )} + {P}_{r} {α}_{r} - {f}_{r} ‖}_{2}^{2} ) \qquad ( 14 )$$

The problem of formula (14) is a least squares problem, which has a closed-form solution as follows:

αᵣ^{(k+1}=(ρI+ρPᵣ^{T}Pᵣ)⁻¹(uᵣ^{(k)}−Pᵣ^{T}vᵣ^{(k)}+ρxᵣ^{(k)}+ρPᵣ^{T}(fᵣ−yᵣ^{(k)})) (15)

All terms containing xᵣ are extracted from formula (6), and the soft thresholding shrinkage operator is used to solve the second sub-problem as follows.

$${x}_{r}^{( k + 1 )} = {argmin}_{{x}_{r}} {‖ {x}_{r} ‖}_{1} + 〈 {u}_{r}^{( k )} , {x}_{r} - {α}_{r}^{( k + 1 )} 〉 + \frac{ρ}{2} {‖ {x}_{r} - {α}_{r}^{( k + 1 )} ‖}_{2}^{2} = {argmin}_{{x}_{r}} {‖ {x}_{r} ‖}_{1} + \frac{ρ}{2} {‖ {x}_{r} - ( {α}_{r}^{( k + 1 )} - \frac{{u}_{r}^{( k )}}{ρ} ) ‖}_{2}^{2} \qquad ( 16 )$$

Referring to the following soft thresholding shrinkage operator:

$$soft ( ϕ , Δ ) = \{ \begin{matrix}ϕ - Δ , ϕ > Δ \\ ϕ + Δ , ϕ < - Δ \\ 0 , otherwise\end{matrix} \qquad ( 17 )$$

where ϕ∈ [symbol] , Δ>0, the solution of the second sub-problem xᵣ is as follows:

$${x}_{r}^{( k + 1 )} = soft ( {α}_{r}^{( k + 1 )} - \frac{{u}_{r}^{( k )}}{ρ} , \frac{1}{ρ} ) \qquad ( 18 )$$

where ϕ represents a variable; [symbol] represents a set of real numbers; Δ represents a threshold value.

All terms containing yᵣ are extracted from formula (6) and the third sub-problem is solved by using the soft thresholding shrinkage operator:

$${y}_{r}^{( k + 1 )} = {arg min}_{{y}_{r}} τ {‖ {y}_{r} ‖}_{1} + 〈 {v}_{r}^{( k )} , {y}_{r} + {P}_{r} {α}_{r}^{( k + 1 )} - {f}_{r} 〉 + 〈 {w}_{r}^{( k )} , {y}_{r} - {s}_{r}^{( k )} 〉 + \frac{ρ}{2} ( {‖ {y}_{r} + {P}_{r} {α}_{r}^{( k + 1 )} - {f}_{r} ‖}_{2}^{2} + {‖ {y}_{r} - {s}_{r}^{( k )} ‖}_{2}^{2} ) = {arg min}_{{y}_{r}} τ {‖ {y}_{r} ‖}_{1} + ρ {‖ {y}_{r} - \frac{1}{2} ( {f}_{r} + {s}_{r}^{( k )} - {P}_{r} {α}_{r}^{( k + 1 )} - \frac{1}{ρ} ( {v}_{r}^{( k )} + {w}_{r}^{( k )} ) ) ‖}_{2}^{2} = soft ( \frac{1}{2} ( {f}_{r} + {s}_{r}^{( k )} - {P}_{r} {α}_{r}^{( k + 1 )} - \frac{1}{ρ} ( {v}_{r}^{( k )} + {w}_{r}^{( k )} ) ) , \frac{τ}{2 ρ} ) \qquad ( 19 )$$

where τ represents the regularization parameter.

All terms containing sᵣ are extracted from formula (6) and the fourth sub-problem is solved as follows:

$${s}_{r}^{( k + 1 )} = {arg min}_{{s}_{r}} γ {s}_{r}^{T} {L}_{{𝒢}_{r}} {s}_{r} + 〈 {w}_{r}^{( k )} , {y}_{r}^{( k )} - {s}_{r} 〉 + \frac{ρ}{2} {‖ {y}_{r}^{( k + 1 )} - {s}_{r} ‖}_{2}^{2} ) = {( 2 γ {L}_{{𝒢}_{r}} + ρ I )}^{- 1} ( {w}_{r}^{( k )} + ρ {y}_{r}^{( k + 1 )} ) \qquad ( 20 )$$

uᵣ is obtained after the iteration:

uᵣ^{(k+1)}=uᵣ^{(k)}+ρ(xᵣ^{(k+1)}−αᵣ^{(k+1)}) (21)
vᵣ is obtained after the iteration:

vᵣ^{(k+1)}=vᵣ^{(k)}+ρ(yᵣ^{(k+1)}+Pᵣαᵣ^{(k+1)}−fᵣ) (22)
wᵣ is obtained after the iteration:

wᵣ^{(k+1)}=wᵣ^{(k)}+ρ(yᵣ^{(k+1)}−sᵣ^{(k+1)}) (23)

The termination conditions of the iteration is determined, and the iteration is stopped if the termination conditions are met. The termination conditions of the iteration are as follows:

∥xᵣ^{(k+1}−αᵣ^{(k+1)}∥_{∞}≤ε₁, ∥yᵣ^{(k+1)}+Pᵣαᵣ^{(k+1)}−fᵣ∥_{∞}≤ε₂, and ∥yᵣ^{(k+1)}−sᵣ^{(k+1)}∥_{∞}≤ε₃;

After the iteration of the above step, the solutions of sᵣ obtained are the solutions of formula (5).

Step 5) s₁, . . . ,sᵣ_{ₘₐₓ} are matrixed and then re-integrated to obtain a foreground image S, i.e., a foreground image of the whole image.

The precision, recall and F1 score of the obtained foreground map and ground truth foreground are calculated to evaluate the superiority of the segmentation effect.

### Simulation Example 1

In this example, a manually generated synthetic image is input, that is, a foreground component is inserted into a smooth background image. In this example, the number of graph Fourier basis functions, M, is selected to be 10. Meanwhile, the block size is selected to be l=64, and the regularization parameters are set to τ=0.15 and γ=0.05, and the constraint parameters are set to ε₁=ε₂=ε₃=10⁻⁶.

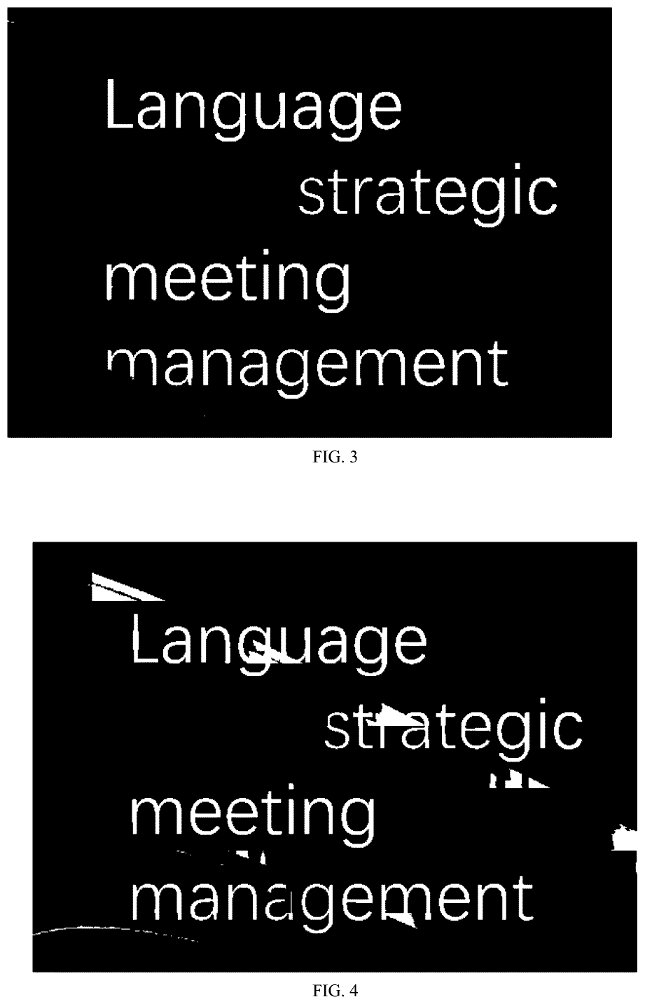

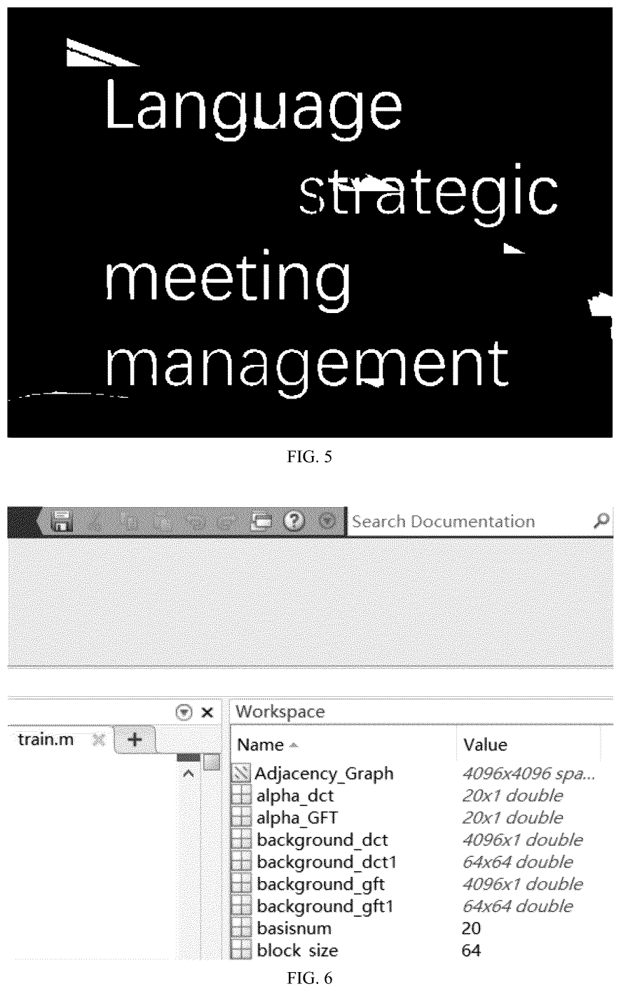

The synthetic image is input into the model in the technical scheme of the disclosure, and comparison of segmentation foreground images are shown in FIG. 1 to FIG. 5, in which FIG. 1 shows an original image, FIG. 2 shows a ground truth foreground, FIG. 3 shows a foreground map by the technical scheme of the disclosure, FIG. 4 shows a foreground map by the LAD method, and FIG. 5 shows a foreground map by the SDTV method. It can be observed that the segmentation effect of the model in the technical scheme of the disclosure is the best. Compared with the least absolute deviations (shorted as LAD) method and the sparse decomposition and total variation minimization (SDTV) method, the precision, recall and F1 score of the foreground images segmented by the technical scheme of disclosure and the above methods are calculated according to the ground truth foreground. The results are shown in Table 1, and it can be observed that the technical scheme of the disclosure is superior to the above existing methods.

TABLE 1
Performance measurement of segmentation results

| Segmentation algorithm | Precision | Recall | F1 |
|---|---|---|---|
| LAD | 80.83% | 82.08% | 81.45% |
| SDTV | 85.99% | 82.63% | 84.28% |
| The method of | 99.45% | 84.34% | 91.28% |
| the disclosure | | | |

### Simulation example 2

This example inputs the screen content image captured by screen snapshot. The settings of parameters are consistent with those of the simulation example 1.

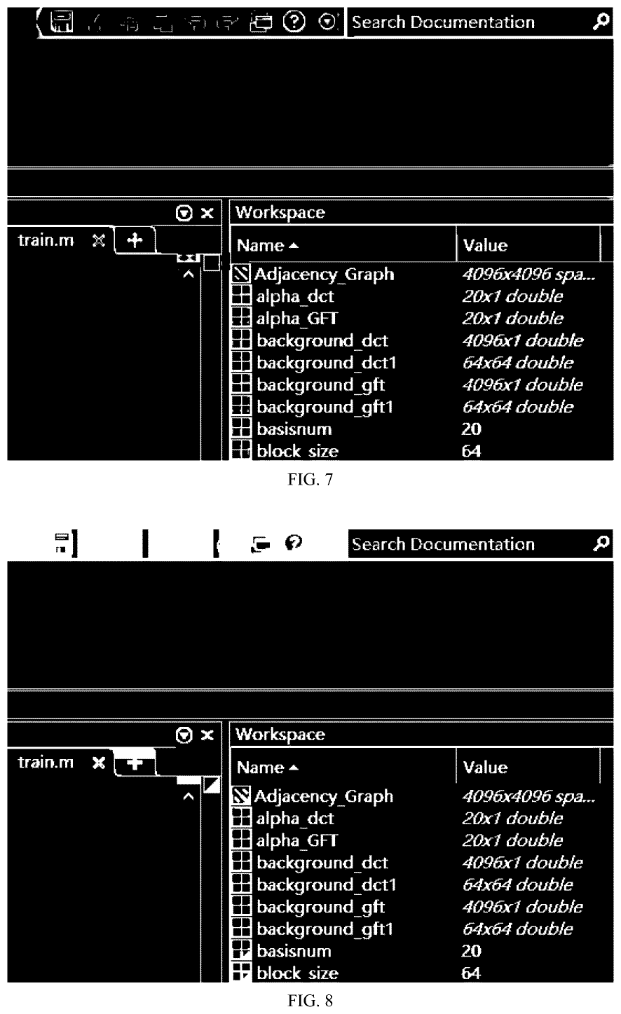

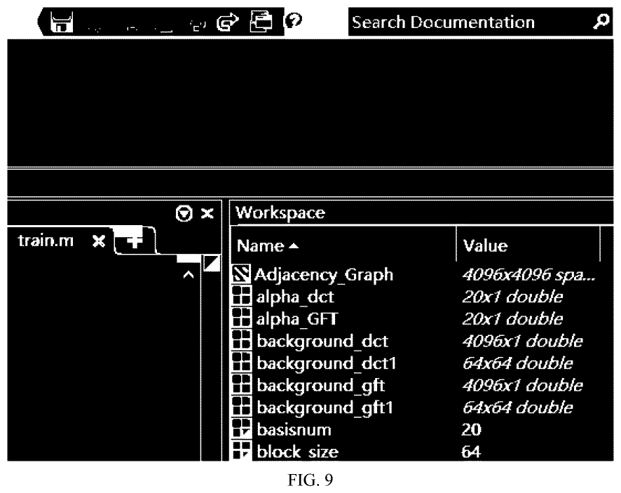

The screen content image is input into the model of the technical scheme, the comparison of segmentation foreground images are shown in FIGS. 6 to 9, in which FIG. 6 shows an original image, FIG. 7 shows a foreground map by the technical scheme, FIG. 8 shows a foreground map by the LAD method, and FIG. 9 shows a foreground map by the SDTV method. It can be observed that the segmentation effect of the model in the technical scheme is the best.

The above-mentioned embodiments are only preferred embodiments for fully explaining the disclosure, and the scope of protection of the disclosure is not limited thereto. Equivalent substitutions or changes made by those skilled in the art on the basis of the disclosure are within the scope of protection of the disclosure. The scope of protection of the disclosure is subject to the claims.

What is claimed is:

1. A image foreground-background segmentation method based on sparse decomposition and graph Laplacian regularization, comprising:
step 1) dividing an image into a plurality of non-overlapping image blocks;
step 2) establishing a foreground-background segmentation model of the image block, and wherein the foreground-background segmentation model is expressed as follows:
$${min}_{{s}_{r} , {α}_{r}} {‖ {α}_{r} ‖}_{0} + τ {‖ {s}_{r} ‖}_{0} + γ {s}_{r}^{T} {L}_{{𝒢}_{r}} {s}_{r} \\ s . t . {f}_{r} = {P}_{r} {α}_{r} + {s}_{r} \qquad ( 3 )$$
where τ and γ are regularization parameters; ∥αᵣ∥₀ represents minimizing the nonzeros entries of the parameter αᵣ by using 10-norm; ∥sᵣ∥₀ represents foreground pixels sᵣ where the number of non-zero components are smaller; sᵣ^{T} [symbol] sᵣ represents a graph Laplacian regularization term, which is used to characterize connectivity of foreground text and graphics; fᵣ=Pᵣαᵣ+sᵣ represents a constraint term; fᵣ corresponds to vectorization of Fᵣ(x,y) and sᵣ corresponds to vectorization of Sᵣ(x,y); Pᵣ is a matrix with a size l²×M and αᵣ=[α_{r,1}, . . . , α_{r,M}]^{T};
step 3) using a 11-norm to deal with a convex problem according to the foreground-background segmentation model, and obtaining a problem as follows:
$${min}_{{s}_{r} , {α}_{r}} {‖ {α}_{r} ‖}_{1} + τ {‖ {s}_{r} ‖}_{1} + γ {s}_{r}^{T} {L}_{{𝒢}_{r}} {s}_{r} \\ s . t . {f}_{r} = {P}_{r} {α}_{r} + {s}_{r} \qquad ( 4 )$$
step 4) dividing the problem into a plurality of sub-problems, and solving the plurality of sub-problems by iteration according to the foreground-background segmentation model of the image established by formula (3); and
step 5) after the iteration of the above step 4), obtaining solutions sᵣ (r=1, . . . ,rₘₐₓ) of above problem; matrixing sᵣ, and patching the sᵣ into S, which is a foreground image of the whole image.

2. The image foreground-background segmentation method based on sparse decomposition and graph Laplacian regularization according to claim 1, wherein the plurality of non-overlapping image blocks in step 1) are obtained by the following manner:
dividing the image into rₘₐₓ numbers of the non-overlapping image blocks with a size of l×l; wherein the r-th image block of the rₘₐₓ numbers of the non-overlapping image blocks is expressed as follows:
Fᵣ(x,y)=Σₘ₌₁^{M}α_{r,m}P_{r,m}9x,y)+Sᵣ(x,y) (1)
where r=1, . . . ,rₘₐₓ; x represents a horizontal coordinate and y represents a vertical coordinate; Σₘ₌₁^{M}α_{r,m}P_{r,m}(x,y) corresponds to a smooth background region, P_{r,m}(x,y) represents a graph Fourier basis; α_{r,m} represents a model parameter; Sᵣ(x,y) corresponds to the foreground pixels; and
re-describing formula (1) to formula (2) by vectorizing a matrix into a vector:
fᵣ=Pᵣαᵣ+sᵣ (2)
where fᵣ corresponds to the vectorization of Fᵣ(x,y) and sᵣ corresponds to the vectorization of Sᵣ(x,y); Pᵣ is the matrix with the size l²×M, and αᵣ=[α_{r,1}, . . . ,α_{r,M}]^{T}.

3. The image foreground-background segmentation method based on sparse decomposition and graph Laplacian regularization according to claim 1, wherein the plurality of sub-problems in step 4) are obtained by the following manner:
before using an alternating direction method of multipliers to solve the problem, rewriting the problem equivalently as follows:
$${min}_{{α}_{r} , {x}_{r} , {y}_{r} , {s}_{r}} {‖ {x}_{r} ‖}_{1} + τ {‖ {y}_{r} ‖}_{1} + γ {s}_{r}^{T} {L}_{{𝒢}_{r}} {s}_{r} \\ s . t . {x}_{r} = {α}_{r} , {y}_{r} = {f}_{r} - {P}_{r} {α}_{r} , {y}_{r} = {s}_{r} \qquad ( 5 )$$
where xᵣ is an auxiliary variable, which is equivalent to αᵣ before equivalent rewriting; yᵣ is another auxiliary variable, which is equivalent to sᵣ before equivalent rewriting;
using the alternating direction method of multipliers to express an augmented Lagrangian function of the rewritten problem as follows:
$$ℓ ( {α}_{r} , {x}_{r} , {y}_{r} , {s}_{r} , {u}_{r} , {v}_{r} , {w}_{r} ) = {‖ {x}_{r} ‖}_{1} + τ {‖ {y}_{r} ‖}_{1} + γ {s}_{r}^{T} {L}_{{𝒢}_{r}} {s}_{r} + 〈 {u}_{r} , {x}_{r} - {α}_{r} 〉 + 〈 {v}_{r} , {y}_{r} + {P}_{r} {α}_{r} - {f}_{r} 〉 + 〈 {w}_{r} , {y}_{r} - {s}_{r} 〉 + \frac{ρ}{2} ( {‖ {x}_{r} - {α}_{r} ‖}_{2}^{2} + {‖ {y}_{r} + {P}_{r} {α}_{r} - {f}_{r} ‖}_{2}^{2} + {‖ {y}_{r} - {s}_{r} ‖}_{2}^{2} ) \qquad ( 6 )$$
where uᵣ,vᵣ,wᵣ represent Lagrange multipliers of a dual variable; [symbol] ⋅,⋅ [symbol] represents an inner product; ρ represents a penalty parameter; and [symbol] represents a graph Laplacian matrix;
dividing the rewritten problem into the plurality of sub-problems and solving the plurality of sub-problems one by one by the iteration:
$${α}_{r}^{( k + 1 )} = {arg min}_{{α}_{r}} ℓ ( {α}_{r} , {x}_{r}^{( k )} , {y}_{r}^{( k )} , {s}_{r}^{( k )} , {u}_{r}^{( k )} , {v}_{r}^{( k )} , {w}_{r}^{( k )} ) \qquad ( 7 )$$
$${x}_{r}^{( k + 1 )} = {arg min}_{{x}_{r}} ℓ ( {α}_{r}^{( k + 1 )} , {x}_{r} , {y}_{r}^{( k )} , {s}_{r}^{( k )} , {u}_{r}^{( k )} , {v}_{r}^{( k )} , {w}_{r}^{( k )} ) \qquad ( 8 )$$
$${y}_{r}^{( k + 1 )} = {arg min}_{{y}_{r}} ℓ ( {α}_{r}^{( k + 1 )} , {x}_{r}^{( k + 1 )} , {y}_{r} , {s}_{r}^{( k )} , {u}_{r}^{( k )} , {v}_{r}^{( k )} , {w}_{r}^{( k )} ) \qquad ( 9 )$$
$${s}_{r}^{( k + 1 )} = {arg min}_{{s}_{r}} ℓ ( {α}_{r}^{( k + 1 )} , {x}_{r}^{( k + 1 )} , {y}_{r}^{( k + 1 )} , {s}_{r} , {u}_{r}^{( k )} , {v}_{r}^{( k )} , {w}_{r}^{( k )} ) \qquad ( 10 )$$
$${u}_{r}^{( k + 1 )} = {u}_{r}^{( k )} + ρ ( {x}_{r}^{( k + 1 )} - {α}_{r}^{( k + 1 )} ) \qquad ( 11 )$$
$${v}_{r}^{( k + 1 )} = {v}_{r}^{( k )} + ρ ( {y}_{r}^{( k + 1 )} + {P}_{r} {α}_{r}^{( k + 1 )} - {f}_{r} ) \qquad ( 12 )$$
$${w}_{r}^{( k + 1 )} = {w}_{r}^{( k )} + ρ ( {y}_{r}^{( k + 1 )} - {s}_{r}^{( k + 1 )} ) \qquad ( 13 )$$
where [symbol] * represents a value of the symbol ⋅ when the formula * reaches a minimum value; k represents the k-th iteration; *^{(k+1)} represents a result of the formula * after the (k+1)-th iteration; and *^{(k)} represents a result of the formula * after the k-th iteration.

4. The image foreground-background segmentation method based on sparse decomposition and graph Laplacian regularization according to claim 1, wherein the solving the plurality of sub-problems by the iteration, comprises:
extracting all terms containing αᵣ, xᵣ, yᵣ, sᵣ from formula (6) respectively;
determining termination conditions of the iteration, and stopping the iteration in response to the termination conditions of the iteration being met; wherein the termination conditions of the iteration are as follows:
∥xᵣ^{(k+1)}−αᵣ^{(k+1)}∥_{∞}≤ε₁, ∥yᵣ^{(k+1)}+Pᵣαᵣ^{k+1)}−fᵣ∥_{∞}≤ε₂, and ∥yᵣ^{(k+1)}−sᵣ^{(k+1)}∥_{∞}≤ε₃;
where ∥⋅∥_{∞} is an infinite norm, which represents a maximum absolute value of all elements in a vector; ε₁, ε₂, and ε₃ are constraint parameters respectively; αᵣ^{(k+1)} represents a result of αᵣ after the (k+1)-th iteration; sᵣ^{(k+1)} represents a result of sᵣ after the (k+1)-th iteration; xᵣ^{(k+1)} represents a result of xᵣ after the (k+1)-th iteration; xᵣ represents an auxiliary variable, which is equivalent to αᵣ; yᵣ^{(k+1)} represents a result of yᵣ after the (k+1)-th iteration; yᵣ represents an auxiliary variable, which is equivalent to sᵣ.

5. The image foreground-background segmentation method based on sparse decomposition and graph Laplacian regularization according to claim 4, wherein in step 4), all terms containing αᵣ are extracted from formula (6) and a first sub-problem of the plurality of sub-problems is solved by the following manner:
$${α}_{r}^{( k + 1 )} = {arg min}_{{α}_{r}} 〈 {u}_{r}^{( k )} , {x}_{r}^{( k )} - {α}_{r} 〉 + 〈 {v}_{r}^{( k )} , {y}_{r}^{( k )} + {P}_{r} {α}_{r} - {f}_{r} 〉 + \frac{ρ}{2} ( {‖ {x}_{r}^{( k )} - {α}_{r} ‖}_{2}^{2} + {‖ {y}_{r}^{( k )} + {P}_{r} {α}_{r} - {f}_{r} ‖}_{2}^{2} ) \qquad ( 14 )$$
wherein a problem of formula (14) is a least squares problem, which has a closed-form solution as follows:
αᵣ^{(k+1}=ρI+ρPᵣ^{T}Pᵣ)⁻¹(uᵣ^{(k)}−Pᵣ^{T}vᵣ^{(k)}+ρxᵣ^{(k)}+ρPᵣ^{T}(fᵣ−yᵣ^{(k)})) (15)
where I represent a unit matrix.

6. The image foreground-background segmentation method based on sparse decomposition and graph Laplacian regularization according to claim 4, wherein in step 4), all terms containing xᵣ are extracted from formula (6) and a soft thresholding shrinkage operator is used to solve a second sub-problem of the plurality of sub-problems by the following manner:
$${x}_{r}^{( k + 1 )} = {arg min}_{{x}_{r}} {‖ {x}_{r} ‖}_{l} + 〈 {u}_{r}^{( k )} , {x}_{r} - {α}_{r}^{( k + 1 )} 〉 + \frac{ρ}{2} {‖ {x}_{r} - {α}_{r}^{( k + 1 )} ‖}_{2}^{2} = {arg min}_{{x}_{r}} {‖ {x}_{r} ‖}_{l} + \frac{ρ}{2} {‖ {x}_{r} - ( {α}_{r}^{( k + 1 )} - \frac{{u}_{r}^{( k )}}{ρ} ) ‖}_{2}^{2} \qquad ( 16 )$$
wherein the soft thresholding shrinkage operator is as follows:
$$soft ( ϕ , Δ ) = \{ \begin{matrix}ϕ - Δ , ϕ > Δ \\ ϕ + Δ , ϕ < - Δ \\ 0 , otherwise\end{matrix} \qquad ( 17 )$$
where ϕ∈ [symbol] , Δ>0; and a solution of the second sub-problem is as follows:
$${x}_{r}^{( k + 1 )} = soft ( {α}_{r}^{( k + 1 )} - \frac{{u}_{r}^{( k )}}{ρ} , \frac{1}{ρ} ) \qquad ( 18 )$$
where ϕ represents a variable; [symbol] represents a set of real numbers; and Δ represents a threshold value.

7. The image foreground-background segmentation method based on sparse decomposition and graph Laplacian regularization according to claim 4, wherein in step 4), all terms containing yᵣ are extracted from formula (6) and a soft thresholding shrinkage operator is used to solve a third sub-problem of the plurality of sub-problems by the following manner:
$${y}_{r}^{( k + 1 )} = {arg min}_{{y}_{r}} τ {‖ {y}_{r} ‖}_{1} + 〈 {v}_{r}^{( k )} , {y}_{r} + {P}_{r} {α}_{r}^{( k + 1 )} - {f}_{r} 〉 + 〈 {w}_{r}^{( k )} , {y}_{r} - {s}_{r}^{( k )} 〉 + \frac{ρ}{2} ( {‖ {y}_{r} + {P}_{r} {α}_{r}^{( k + 1 )} - {f}_{r} ‖}_{2}^{2} + {‖ {y}_{r} - {s}_{r}^{( k )} ‖}_{2}^{2} ) = {arg min}_{{y}_{r}} τ {‖ {y}_{r} ‖}_{1} + ρ {‖ {y}_{r} - \frac{1}{2} ( {f}_{r} + {s}_{r}^{( k )} - {P}_{r} {α}_{r}^{( k + 1 )} - \frac{1}{ρ} ( {v}_{r}^{( k )} + {w}_{r}^{( k )} ) ) ‖}_{2}^{2} = soft ( \frac{1}{2} ( {f}_{r} + {s}_{r}^{( k )} - {P}_{r} {α}_{r}^{( k + 1 )} - \frac{1}{ρ} ( {v}_{r}^{( k )} + {w}_{r}^{( k )} ) ) , \frac{τ}{2 ρ} ) \qquad ( 19 )$$
where τ represents the regularization parameter.

8. The image foreground-background segmentation method based on sparse decomposition and graph Laplacian regularization according to claim 4, wherein in step 4), all terms containing sᵣ are extracted from formula (6) and a fourth sub-problem is solved by the following manner:
$${s}_{r}^{( k + 1 )} = {arg min}_{{s}_{r}} γ {s}_{r}^{T} {L}_{{𝒢}_{r}} {s}_{r} + 〈 {w}_{r}^{( k )} , {y}_{r}^{( k )} - {s}_{r} 〉 + \frac{ρ}{2} {‖ {y}_{r}^{( k + 1 )} - {s}_{r} ‖}_{2}^{2} ) = {( 2 γ {L}_{{𝒢}_{r}} + ρ I )}^{- 1} ( {w}_{r}^{( k )} + ρ {y}_{r}^{( k + 1 )} ) \qquad ( 20 )$$
wherein uᵣ is obtained after the iteration:
uᵣ^{(k+1)}=uᵣ^{(k)}+ρ(xᵣ^{(k+1)}−αᵣ^{(k+1)}) (21)
wherein vᵣ is obtained after the iteration:
vᵣ^{(k+1)}=vᵣ^{(k)}+ρ(yᵣ^{(k+1)}+Pᵣαᵣ^{(k+1)}−fᵣ) (22)
wherein wᵣ is obtained after the iteration:
wᵣ^{(k+1)}=wᵣ^{(k)}+ρ(yᵣ^{(k+1)}−sᵣ^{(k+1)}) (23)
where [symbol] represents a graph Laplacian matrix.

9. An image foreground-background segmentation system based on sparse decomposition and graph Laplacian regularization, comprising: a memory, a processor and a computer program stored in the memory and executable on the processor, wherein the processor is configured, when executes the computer program, to implement the method according to claim 1.
